(19) United States
(12) Patent Application Publication
(10) Pub. No.: US 2026/0012513 A1
(43) Pub. Date: Jan. 8, 2026

(54) SYSTEM AND METHOD FOR OVER-THE-AIR PROGRAMMING OF COMMUNICATIVELY CONNECTED WORK MACHINES

(71) Applicant: Oshkosh Corporation, Oshkosh, WI (US)

(72) Inventors: Korry D. Kobel, Oshkosh, WI (US); Fredric L. Yutzy, Oshkosh, WI (US); Dan Adamson, Oshkosh, WI (US); Patrick Booth, Oshkosh, WI (US); Brian Mohlman, Oshkosh, WI (US)

(73) Assignee: Oshkosh Corporation, Oshkosh, WI (US)

(21) Appl. No.: 19/323,938

(22) Filed: Sep. 9, 2025

Related U.S. Application Data
(63) Continuation of application No. PCT/US2024/019222, filed on Mar. 8, 2024.
(60) Provisional application No. 63/451,387, filed on Mar. 10, 2023.
(60) Provisional application No. 63/451,390, filed on Mar. 10, 2023.
(60) Provisional application No. 63/489,562, filed on Mar. 10, 2023.
(60) Provisional application No. 63/489,538, filed on Mar. 10, 2023.
(60) Provisional application No. 63/451,506, filed on Mar. 10, 2023.
(60) Provisional application No. 63/489,558, filed on Mar. 10, 2023.
(60) Provisional application No. 63/489,560, filed on Mar. 10, 2023.
(60) Provisional application No. 63/451,342, filed on Mar. 10, 2023.
(60) Provisional application No. 63/451,351, filed on Mar. 10, 2023.
(60) Provisional application No. 63/489,533, filed on Mar. 10, 2023.
(60) Provisional application No. 63/489,531, filed on Mar. 10, 2023.
(60) Provisional application No. 63/451,504, filed on Mar. 10, 2023.

(51) Int. Cl. H04L 67/00; H04L 67/52

(52) U.S. Cl. CPC H04L 67/34; H04L 67/52

(57) ABSTRACT

System and methods relate to over-the-air programming for a work machine. The system includes a connectivity module coupled to the work machine. The system also includes one or more processing circuits comprising one or more memory devices configured to cause one or more processors to: designate a desired software version; receive an indication of a software version installed on the work machine; based on the indication of the software version installed on the work machine, determine whether the work machine is eligible to receive the desired software version; send the desired software version to the connectivity module physically coupled to the work machine; after sending the desired software version to the connectivity module, send a command to initiate an installation of the desired software version from the connectivity module to the work machine; and cause the desired software version to install to the work machine via the connectivity module.

### CROSS-REFERENCE TO RELATED APPLICATIONS

This application is a continuation of International Application No. PCT/US2024/019222, filed Mar. 8, 2024, which claims the benefit of and priority to (i) U.S. Provisional Application No. 63/451,342, filed on Mar. 10, 2023, (ii) U.S. Provisional Application No. 63/451,351, filed on Mar. 10, 2023, (iii) U.S. Provisional Application No. 63/451,387, filed on Mar. 10, 2023, (iv) U.S. Provisional Application No. 63/451,390, filed on Mar. 10, 2023, (v) U.S. Provisional Application No. 63/489,533, filed on Mar. 10, 2023, (vi) U.S. Provisional Application No. 63/451,504, filed on Mar. 10, 2023, (vii) U.S. Provisional Application No. 63/489,562, filed on Mar. 10, 2023, (viii) U.S. Provisional Application No. 63/451,506, filed on Mar. 10, 2023, (ix) U.S. Provisional Application No. 63/489,531, filed on Mar. 10, 2023, (x) U.S. Provisional Application No. 63/489,538, filed on Mar. 10, 2023, (xi) U.S. Provisional Application No. 63/489,558, filed on Mar. 10, 2023, and (xii) U.S. Provisional Application No. 63/489,560, filed on Mar. 10, 2023, each of which is hereby incorporated by reference herein in its entirety.

### BACKGROUND

Work equipment such as lifts and telehandlers sometimes require identifying, tracking, tasking, monitoring, and servicing at a work site. Such identifying, tracking, tasking, monitoring, and servicing includes ensuring that software and the like on work machines remains up-to-date for each work machine. Managers and operators of working machines typically rely on discrete systems, applications, and methods to perform these functions for each piece of equipment.

### SUMMARY OF THE DISCLOSURE

One exemplary embodiment of the present disclosure relates to a system for over-the-air programming for a work machine. The system includes a connectivity module, the connectivity module communicatively and physically coupled to the work machine; one or more processing circuits comprising one or more memory devices coupled to one or more processors, the one or more memory devices configured to store instructions thereon that, when executed by the one or more processors, cause the one or more processors to designate a desired software version; receive an indication of a software version installed on the work machine; based on the indication of the software version installed on the work machine, determine whether the work machine is eligible to receive the desired software version; send the desired software version to the connectivity module physically coupled to the work machine; after sending the desired software version to the connectivity module, send a command to initiate an installation of the desired software version from the connectivity module to the work machine; and cause the desired software version to install to the work machine via the connectivity module.

Another embodiment related to a system for over-the-air programming for a work machine. The system includes one or more processing circuits comprising one or more memory devices coupled to one or more processors, the one or more memory devices configured to store instructions thereon that, when executed by the one or more processors, cause the one or more processors to receive an indication of a selection of a desired software version, receive a software status of the work machine, the software status corresponding to the desired software version, compare the software status of the work machine with the desired software version, send the desired software version to at least one of a user device, a connectivity module coupled to the work machine, or the work machine, send a signal to initiate a software update process locally between the connectivity module and the work machine, and cause, responsive to sending the signal, the desired software version to install to the work machine via the connectivity module.

In some embodiments, a system for over-the-air programming for communicatively connected work machines includes one or more processing circuits comprising one or more memory devices coupled to one or more processors. The one or more memory devices are configured to store instructions thereon that, when executed by the one or more processors, cause the one or more processors to communicate across a wireless network. For example, the one or more processors may send messages to one or more machines and a user device. The machines and user device may be communicatively connected to the network. The system may generate a graphical user interface (GUI) comprising a list of the one or more machines. The system may also send the GUI to a screen of the user device. A user viewing the user device may selection of a desired software version on the GUI. The system may send a message instructing the one or more machines report the current software versions on the machines to the user device. The software versions of the machines may be received, via the GUI. The system may compare the respective software versions of the one or more machines with the desired software version and determine whether the one or more machines lack the desired software version. The system may physically locate, via the GUI, a machine lacking the desired software version. The system may download the desired software version to the user device. A software update process can be initiated locally between the user device and the respective machine of the one or more machines lacking the desired software version.

Another embodiment relates to a method for over-the-air programming for a work machine. The method includes receiving an indication of a selection of a desired software version; sending, in response to receiving the indication of the selection of the desired software version, an instruction to the work machine to report a respective software status corresponding to the desired software version; receiving the respective software status of the work machine; comparing the respective software status of the work machine with the desired software version; determining whether the work machine lacks the desired software version; sending the desired software version to a connectivity module coupled to the work machine; initiating a software update process locally between the connectivity module and the work machine lacking the desired software version; and causing the work machine to receive the desired software version.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a schematic representation of a work machine including a machine control module according to some embodiments.

FIG. 2 is a schematic representation of a local fleet connectivity system, according to some embodiments.

FIG. 3 is a schematic representation of a system for over-the-air programming for communicatively connected work machines, according to some embodiments.

FIG. 4 is a picture representation of a piece of equipment with a system for over-the-air programming for communicatively connected work machines providing connectivity to a remote user, according to some embodiments.

FIG. 5 is a graphical user interface of the system for over-the-air programming for communicatively connected work machines, according to some embodiments.

FIG. 6 is a picture representation of a work machine with machine specific output data connected to a system for over-the-air programming for communicatively connected work machines, according to some embodiments.

FIG. 7 is a picture representation of a work machine provisioned with an integrated connectivity module and beacon, according to some embodiments.

FIG. 8 is a picture representation of a series of user interface views of a system for over-the-air programming for communicatively connected work machines application hosted on a user device, according to some embodiments.

FIG. 9 is a picture representation of a fleet of work machines at a work site connecting to the local fleet connectivity system, according to some embodiments.

FIG. 10 is a combination picture and drawing representation of work machines connected to a local fleet connectivity system, according to some embodiments.

FIG. 11 is a drawing representing digital machine to machine communications between machines connected to a local fleet connectivity system at a work site, according to some embodiments.

FIG. 12 is a drawing representing a view of user interface of a local fleet connectivity system, according to some embodiments.

FIG. 13 is drawing of another view of the user interface of a local fleet connectivity system of FIG. 13, according to some embodiments.

FIG. 14 is a flow diagram of a method for over-the-air programming for communicatively connected work machines, according to some embodiments.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Work equipment such as lifts and telehandlers sometimes require tracking, tasking, monitoring, and servicing at a work site. Such tracking, tasking, monitoring, and servicing often includes installing software on work machines and ensuring that such software remains up to date or current. Managers and operators of work machines typically rely on discrete systems, applications, and methods to monitor software versions installed on each piece of equipment. It is therefore desirable to provide a means to automatically identify work machines in need of software updates, physically locate the same, and integrate such update functions on a common platform to improve efficiency and reduce costs. Worksites may encompass a large area or many pieces of equipment. It may be desirable to provide a means for quickly and effectively locating and identifying a particular piece of equipment in need of an update via a user device (e.g., a mobile application) and a local area network comprised of work machines. It may also be desirable to provide a means physically locating a particular machine or a group of machines in need of a software update. Files corresponding to the needed software update are downloaded to the user device (e.g., via the mobile application) and/or a communication module coupled to the work machine; in this way, the files can be communicated or installed locally from the user device and/or the communication module(s) to the work machine(s) in need of the update via a connection between the user device and the communication module and/or a control module of the work machine, thereby saving time, improving efficiency, and reducing costs.

Referring to the figures generally, various exemplary embodiments disclosed herein relate to systems and methods for over-the-air programming for communicatively connected work machines. Work machines connected on a local area network may automatically associate a group of machines at a work site and exchange machine group information with nodes connected to the cloud for data processing and for simple fleet management. Via a local fleet connectivity system, for example, the work machines may automatically generate a group of machines as a local fleet, a work site fleet, or other classification such that the automatically generated “work site” group facilitates identification and access of the machines in the group. In a further example, a group of all connected machines on a particular work site may be easily identified, accessed, and grouped by site. The system for over-the-air programming for communicatively connected work machines interoperating with a fleet connectivity system may allow for identification of specific software versions present on all work machines at a job site, present on all work machines within a group, or present on individually selected work machines. The system for over-the-air programming for communicatively connected work machines may interoperate, for example, with a local fleet connectivity system that employs Bluetooth Low Energy (BLE) Machine to Machine (M2M) communication protocols to expand communication and improve productivity at a work site/jobsite by communicating across a local site network mesh to identify and physically locate machines in need of software updates.

Further referring to the figures generally, the various exemplary embodiments disclosed herein relate to systems, apparatuses, and methods for a system for over-the-air programming for communicatively connected work machines that is interoperable with a local fleet connectivity system. In some embodiments, the local fleet connectivity system can comprise work machines, interface modules, work site equipment, communications devices, communications networks, user interface devices, devices hosting self-forming network software (e.g., local fleet connectivity system software), equipment users, equipment maintainers, and equipment suppliers. The information provided to the local fleet connectivity system can be communicated to a machine operator via a user interface. In some embodiments, the user interface includes a real time map, showing a current machine location, and machine software versions (e.g., compared to a current software version, compared to software installed on other work machines at the work site, etc.). In some embodiments, the user interface includes a color-coded map, an audible alarm, or another indicator structured to communicate the location of a work machine in need of a software update to the user. The user may then physically locate the work machine in need of the software update, download files associated with the software update to the user device and/or a communication module coupled to the work machine, and initiate a process to communicate/install the files and software update locally from the user device to the work machine in need of the software update via a connection between the user device and a connectivity module and/or control module associated with the work machine (e.g., a software update is remotely installed to one or more connectivity modules, a user device is then used to review the software update and send a command to transfer/install the software update from the connectivity module to the work machine, etc.).

In some embodiments, the system is configured to send instructions to work machine connectivity modules to report back to the user device the software version(s) installed on the work machine (e.g., receive an indication of a software version installed on the selected work machine). The system may be configured to compare the software version(s) installed on the work machine with a desired or updated software version(s). In other embodiments, the system may designate a desired software version, receive an indication of a software version installed on a work machine (e.g., receive a signal indicating which work machines have a software version dated before a specific date, etc.), and based on the indication of the software version installed on the work machine, determine whether the work machine is eligible to receive the desired software version (e.g., confirm that the work machine has an analogous software type that has a prior version in need of updating, etc.). If the software version(s) installed on the work machine do not match the desired or updated software version(s), the system identifies the work machine as a work machine in need of a software update. The system may be configured to physically locate the work machine in need of a software update. For example, the system may be configured to send instructions to the work machine in need of a software update to illuminate a light or generate a sound, either with a beacon integrated into the connectivity module or with the lights and horn of the machine itself, responsive to a user interaction with an application (e.g., an “identify machine in need of update” application). The system assists users in locating a machine in need of a software update from among a group of machines on a work site through remote activation of visible and audible indicators on the machine (e.g., users enter commands on the mobile application to activate a beacon on a particular machine to distinguish it from a group of physically similar machines on a work site). Additionally, a work machine's lights and horn may be activated by the system for over-the-air programming for communicatively connected work machines. In a further example, a beacon may be provided as a component of the system for over-the-air programming for communicatively connected work machines. In another example, the system for over-the-air programming for communicatively connected work machines system may generate a user interface (e.g., a graphical user interface (GUI)) with a dynamic filter of a map to illustrate a total machine population wherein the map highlights, identifies, or leads to the work machine in need of a software update. The user interface may also enable a remote user to apply such a filter to a specific jobsite network much the same as can be done locally via the mobile app. The respective software update may then be downloaded to the user device via the mobile device, and locally installed on the work machine in need of the software update (e.g., via communications through a mesh network, through a connectivity module, through a local area network, etc.). In further embodiments, approval of the desired software version via a user device may be a prerequisite to the installation of the desired software version from the connectivity module to the work machine.

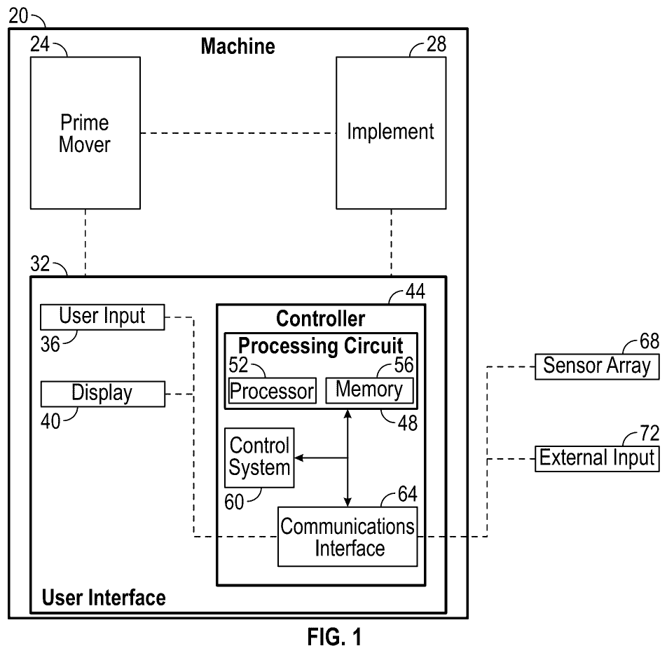

As shown in FIG. 1, a work machine 20 (e.g., a telehandler, a boom lift, a scissor lift, etc.) includes a prime mover 24 (e.g., a spark ignition engine, a compression ignition engine, an electric motor, a generator set, a hybrid system, etc.) structured to supply power to the work machine 20, and an implement 28 driven by prime mover 24. In some embodiments, the implement 28 is a lift boom, a scissor lift, a telehandler arm, etc. A user interface 32 is arranged in communication with the prime mover 24 and the implement 28 to control operations of the work machine 20 and includes a user input 36 that allows a machine operator to interact with the user interface 32, a display 40 for communicating to the machine operator (e.g., a display screen, a lamp or light, an audio device, a dial, or another display or output device), and a control module 44.

As the components of FIG. 1 are shown to be embodied in the work machine 20, the controller 44 may be structured as one or more electronic control units (ECU). The controller 44 may be separate from or included with at least one of an implement control unit, an exhaust after-treatment control unit, a powertrain control module, an engine control module, etc. In some embodiments, the control module 44 includes a processing circuit 48 having a processor 52 and a memory device 56, a control system 60, and a communications interface 64. Generally, the control module 44 is structured to receive inputs and generate outputs for or from a sensor array 68 and external inputs or outputs 72 (e.g., a load map, a machine-to-machine communication, a fleet management system, a user interface, a network, etc.) via the communications interface 64.

The control system 60 generates a range of inputs, outputs, and user interfaces. The inputs, outputs, and user interfaces may be related to a jobsite, a status of a piece of equipment, environmental conditions, equipment telematics, an equipment location, task instructions, sensor data, equipment consumables data (e.g. a fuel level, a condition of a battery), status, location, or sensor data from another connected piece of equipment, communications link availability and status, hazard information, positions of objects relative to a piece of equipment, device configuration data, part tracking data, text and graphic messages, weather alerts, equipment operation, maintenance, and service data, equipment beacon commands, tracking data, performance data, cost data, operating and idle time data, remote operation commands, reprogramming and reconfiguration data and commands, self-test commands and data, software as a service data and commands, advertising information, access control commands and data, onboard literature, machine software revision data, fleet management commands and data, logistics data, equipment inspection data including inspection of another piece of equipment using onboard sensors, prioritization of communication link use, predictive maintenance data, tagged consumable data, remote fault detection data, machine synchronization commands and data including cooperative operation of machines, equipment data bus information, operator notification data, work machine twinning displays, commands, and data, etc.

The sensor array 68 can include physical and virtual sensors for determining work machine states, work machine conditions, work machine locations, loads, and location devices.

In some embodiments, the sensor array includes a GPS device, a LIDAR location device, inertial navigation, or other sensors structured to determine a position of the equipment 20 relative to locations, maps, other equipment, objects, or other reference points. The sensor array may be activated in response to a command from a user device, for example, activated to broadcast the location/position of the work machine in order to locate the work machine upon determining that its software is out of date, that additional software should be installed, that software should be reinstalled or fixed, etc.

In one configuration, the control system 60 is embodied as machine or computer-readable media that is executable by a processor, such as processor 52. As described herein and amongst other uses, the machine-readable media facilitates performance of certain operations to enable reception and transmission of data. For example, the machine-readable media may provide an instruction (e.g., command, etc.) to, e.g., acquire data. The data may include the current version of various software or programs installed on the work machine 20. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the control system 60 is embodied as hardware units, such as electronic control units. As such, the control system 60 may be embodied as one or more circuitry components including, but not limited to, processing circuitry, network interfaces, peripheral devices, input devices, output devices, sensors, etc. In some embodiments, the control system 60 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the control system 60 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The control system 60 may also include programmable hardware devices such as field programmable gate arrays, programmable array logic, programmable logic devices or the like. The control system 60 may include one or more memory devices for storing instructions that are executable by the processor(s) of the control system 60. The one or more memory devices and processor(s) may have the same definition as provided below with respect to the memory device 56 and processor 52. In some hardware unit configurations, the control system 60 may be geographically dispersed throughout separate locations in the machine. Alternatively, and as shown, the control system 60 may be embodied in or within a single unit/housing, which is shown as the controller 44.

In the example shown, the control module 44 includes the processing circuit 48 having the processor 52 and the memory device 56. The processing circuit 48 may be structured or configured to execute or implement the instructions, commands, and/or control processes described herein with respect to control system 60. The depicted configuration represents the control system 60 as machine or computer-readable media. However, as mentioned above, this illustration is not meant to be limiting as the present disclosure contemplates other embodiments where the control system 60, or at least one circuit of the control system 60, is configured as a hardware unit. All such combinations and variations are intended to fall within the scope of the present disclosure.

The hardware and data processing components used to implement the various processes, operations, illustrative logics, logical blocks, modules and circuits described in connection with the embodiments disclosed herein (e.g., the processor 52) may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., control system 60 may comprise or otherwise share the same processor which, in some example embodiments, may execute instructions stored, or otherwise accessed, via different areas of memory). Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device 56 (e.g., memory, memory unit, storage device) may include one or more devices (e.g., RAM, ROM, Flash memory, hard disk storage) for storing data and/or computer code for completing or facilitating the various processes, layers and modules described in the present disclosure. For example, the memory device 56 may contain applications, software, firmware, code, or other data subject to updates that require periodic monitoring, reinstallation, or revision. The memory device 56 may be communicably connected to the processor 52 to provide computer code or instructions to the processor 52 for executing at least some of the processes described herein. Moreover, the memory device 56 may be or include tangible, non-transient volatile memory or non-volatile memory. Accordingly, the memory device 56 may include database components, object code components, script components, or any other type of information structure for supporting the various activities and information structures described herein.

In an exemplary embodiment, the memory device 56 stores instructions for execution by the processor 52 for a process to facilitate over-the-air programming for communicatively connected work machines. The process to facilitate over-the-air programming for communicatively connected work machines automatically associates machines 20 connected on a near a network to one or more other machines 20. In some embodiments, the automatic associations are based on association rules stored on a work machine or on another network node. In some embodiments, the association rules are based on one or more of a work site designation, a location of a machine, or a code (e.g., a customer key, a manufacturer key, or a maintainer key). In other embodiments, work machines 20 may associate with other work machines that have the same or different software/application/firmware versions installed thereon. In this way, identification of one work machine that requires a software/application/firmware update may lead to immediate identification of like work machines that require similar updates.

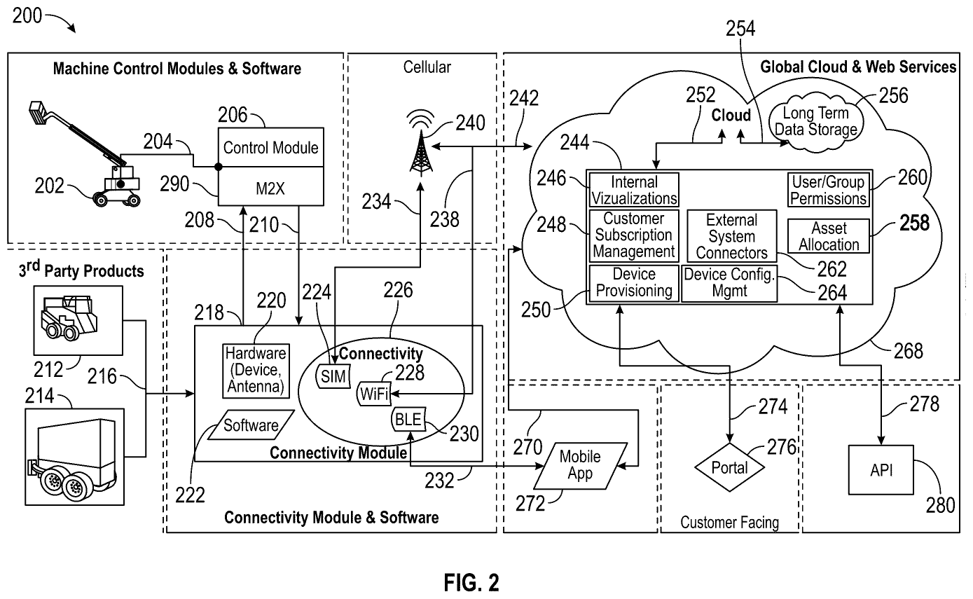

As shown in FIG. 2, a local fleet connectivity system 200 may support the system for over-the-air programming for communicatively connected work machines, both of which interact with a network of nodes. The network of nodes may include one or more work machines 202, each with a control module 206, one or more connectivity modules 218, and one or more network devices hosting, for example, user devices 272 including user interfaces, network portals 276, application interfaces/application programming interfaces 280, data storage systems 256, cloud and web services, and product development tool and application hubs 244.

The work machine 202 is communicably connected to a control module 206. The connection 204 between the work machine 202 and the control module 206 may be wired or wireless thus providing the flexibility to integrate the control module with the work machine 202 or to temporarily attach the control module 206 to the work machine 202. The control module 206 may be configured or may be reconfigurable in both hardware and software to interface with a variety of work machines 202, 212, 214 via the connectivity module 218. The control module 206 may also be configured to report the respective identity/versions of hardware or software configured on the control module 206. The control module 206 may further be configured to communicate to other work machines 202, 212, 214 to report to a user device the identity of hardware/software/firmware/etc. installed on each respective work machine. The control module 206 may comprise an integral power source or may draw power from the work machine 202 or another external source of power. Control modules 206 may be installed on or connected, e.g., via a connection 216, to products (e.g., third party products 212, 214) not configured by the original product manufacturer with a control module 206.

The work machine 202 may communicably connect to the system for over-the-air programming for communicatively connected work machines via a machine-to-X (M2X) module 290. The M2X module 290 is communicably connected to the control module 206. The M2X module 290 establishes one or more communications channels 208, 210 with a connectivity module 218. The connectivity module 218 provides a plurality of links between one or more work machines 202, 212, 214 and the local fleet connectivity system 200. Applications providing functions for the local fleet connectivity system 200 may be run by the M2X modules on one or more work machines 202. One or more user devices 272 may be configured to communicate (e.g., to exchange commands, codes (e.g. a customer key), requests for installed software versions on various work machines, and data) with the connectivity modules of one or more machines via a network connection, for example via a local wireless connectivity system, a local site mesh network comprising the work machines, or via cellular networks (e.g., via cell towers 240) to form a network of interconnections among machines, devices, or nodes. Connections between machines and user devices in the local fleet connectivity system may be provided by a wireless mesh network, for example. In this way, the one or more user devices 272 may be configured to communicate across a wireless network by sending messages to the machines, generate a graphical user interface (GUI) comprising a list of machines, select a specific software version query, broadcast the software version query to the work machines, identify a list of machines lacking the current software version, physically locate, via the GUI, each of the machines lacking the current software version, download the current software version to the user device, and initiate a software update process locally between the user device and each of the machines lacking the current software version.

The connectivity module 218 comprises hardware 220, further comprising antennas, switching circuits, filters, amplifiers, mixers, and other signal processing devices for a plurality of wavelengths, frequencies, etc., software hosted on a non-volatile memory components 222, and a communications manager 226. The communications manager 226 may comprise processing circuits with communications front ends 224, 228, and 230 for one or more signal formats and waveforms including, for example, Bluetooth, Bluetooth low energy, Wi-Fi, cellular, optical, and satellite communications. The connectivity module 218 may function as a gateway device connecting work machine 202 to other work machines 212, 214, remote computing systems 244, 272, 276, and 280, beacons, scheduling or other fleet management and coordination systems, or user devices of the present system which monitor and perform software updates.

The local fleet connectivity system 200 allows for the coordination of multiple machines 202, 212, 214 within the same work site, or a fleet wide control and may integrate with the systems and methods for over-the-air programming for communicatively connected work machines. For example, a work machine 202 may remotely report the results of a self-inspection to a user via a user device 272 indicating the software version currently installed on the work machine 202. The user device 272 may compare the software version currently installed on the work machine 202 with a list of desire/most-up-to-date software versions. Upon detecting a match, the user device 272 may determine that the software on the work machine 202 is up to date and terminate the method. Upon detecting a mismatch, the user device 272 may determine that the work machine 202 requires a software update, broadcast a command to the work machine 202 to display its location (e.g., report its location on a map, activate an audible or visual signal on the work machine 202, etc.). The user device 272 may then download a file or files associated with the needed software update from the local area network, the cloud, other nodes on the system, etc. Finally, the user device may communicate or locally install the file or files associated with the software update onto the work machine 202. Such installation could occur by communicating the files and software update to the work machine 202 via the fleet connectivity system 200, via the connectivity module 218, and/or via the control module 206 work machine 202 pair.

The local fleet connectivity system 200 provides connectivity between work machines 202, 212, 214 and remotely hosted user interfaces 272, network portals 276, application interfaces/application programming interfaces 280, data storage systems 256, cloud and web services 268, and product development tool and application hubs 244 that function as an Internet of Things (IoT) system for operation, control, and support of work machines 202, 212, 214 and users of work machines. Connections 232, 234, 238, 242, 252, 254, 270, 274, and 278 between nodes connected to the local fleet connectivity system 200 may comprise, for example, cellular networks, or other existing or new means of digital connectivity that may be used to identify work machines in need of update, list said work machines on a mobile application on the a user device, physically locate said work machines via the mobile application and/or a local area network, and download and install the needed software update to said work machines.

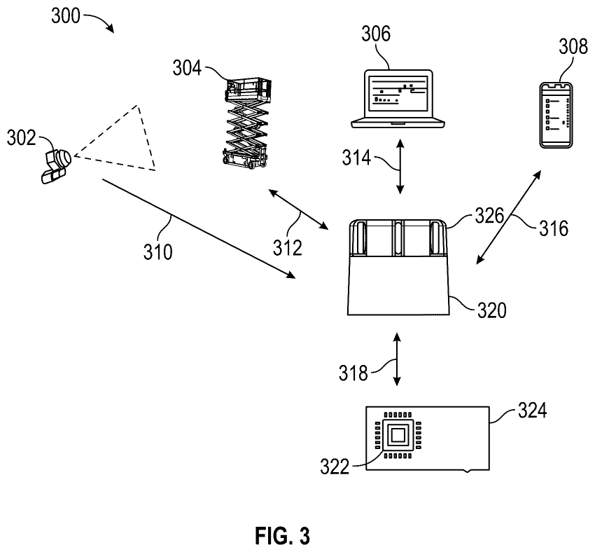

FIG. 3 shows a system for over-the-air programming for communicatively connected work machines 300 according to an exemplary embodiment. As shown in FIG. 3, the connectivity module 320 functions as a communications interface between a control system 322 of the work machine 324 and other elements connected to the system for over-the-air programming for communicatively connected work machines 300. The connectivity module 320 may be part of the work machine 324 or may be physically coupled to the work machine 324. The connectivity module 320 may exchange commands and data (e.g., reporting installed software/firmware versions, reinstalling software, updating installed software, etc.) 318 with the control system 322 of the work machine 324, sensor data 310 with auxiliary sensors 302, machine data 312 with another machine 304, commands and data 314 with a node or portal (e.g., remote computing device 306), and commands and data 316 with a user device 308 running an application for the system for over-the-air programming for communicatively connected work machines 300. Specifically, the connectivity module 320 may identify currently installed software versions and related data between work machines 304, 324, user devices 308, and/or remote computing devices 306 to form a network of interconnections among machines, devices, or nodes that facilitates identification of work machines in need of software updates, pinpointing the location of the work machines in need of updates, and providing local installation of updated software/firmware/etc. to said machines.

In some embodiments, in response to a user selection of an update query (e.g., a command comparing installed software on work machines to a list of desired software, etc.) on an application hosted on the user device 308, one or more machines in need of a software update can be located and/or identified by one or both of a visual or audible signal from the selected machine or from the connectivity module coupled to the machine. In other embodiments, the user device 308 may command the work machine in need of a software update to report its location to user device 308. The location may then be displayed on a GUI such as a map, directional guidance system, address, lot/building identifier, machine serial number identifier, etc. The connectivity module 320 may also include and/or function as a beacon 326 that may include one or both of a light or sound generator and may be configured to identify a machine in need of a software update by generating one or both of a visual or audible signal (e.g., alerts, indications, etc.). The connectivity module 320 may, for example, include a beacon 326 that includes a light (e.g., an RGB LED light) which is lit when a user presses a button on an application (e.g., an identify machine in need of update application on a user device 308). Additionally, or alternatively, the connectivity module 320 may be communicatively coupled to one or more lights (e.g., headlights, cabin lights, etc.) of the work machine 324 (e.g., via the control system 322) and can instruct the lights to generate the visible signals in response to the selection of a button on the user device 308. The beacon 326 may additionally or alternatively include a speaker to provide the audible signals. Additionally, or alternatively, the connectivity module 320 may be communicatively coupled to a horn of the work machine 324 (e.g., via the control system 322) and can instruct the horn to sound to generate the audible signal in response to the selection of a button on the user device 308. The visual and audible signals can be used in conjunction or independently of one another. The beacon 326 may emit any or all combinations of frequency, color, patterns etc. of light and may emit any sound or message (e.g., recorded or computer-generated speech). The connectivity module 320 may be a self-contained unit. For example, the connectivity module 320 may be installed on or connected to machines not configured by the original product manufacturer with a connectivity module 320 and may be configured to communicate with the control module of the machine.

The system for over-the-air programming for communicatively connected work machines 300 may, for example dynamically filter a user interface map to illustrate a total machine population connected to the equipment identification system. Such filtering may begin by listing all machines located at a worksite and proceed to narrow down or isolate specific machines based on queries by the user (e.g., machines with a software version installed earlier than a certain date, machines running specific software versions, all machines not running a selected software version, etc.). Machines meeting the user selected query related to software status/version may then be highlighted or singled out on the map, guiding the user to those machines in need of a software update. In a further example, a remote user may apply a filter to a specific work site network, much the same as can be done locally, via a mobile application. This allows a remote user to apply the desired user configurable rules to assist a local user that does not have access to a user interface of the system for over-the-air programming for communicatively connected work machines 300. The local user may then move to the identified machine in need of an update and install the needed software version. In some embodiments, the beacon 326 on the connectivity module 320 may include a light that may be used to illustrate or illuminate various machine statuses (e.g., software up-to-date, software out-of-date, software version unknown, etc.). For example, the light on the beacon 326 may be green when the specific software identified on the user device is up-to-date on the machine or matched the query sent to the machine by the user. An application on a user device 308 can be used as an interface for a user to select which status they want to be displayed on a fleet within the connected range (e.g., which specific software the user is interested in monitoring) of a user device. The user may selectively command the beacons of one or more machines within the selected range to indicate the status or condition of the software installed on the associated machine. For example, a user may select an option that turns the light green on machines that contain fully up-to-date software packages and turns the light red on machines that contain out-of-date software/firmware/applications/etc. In some examples, selections may be independent of or in conjunction with the filter criteria of a desired subset of a fleet. In some embodiments, the user device 308 may be configured to send a command to the connectivity module 320 of a selected machine to command the machine to download/receive/install an updated software package from the user device 308. In some embodiments, the user device 308 may be configured to send a command to the connectivity module 320 of a selected machine uninstall out-of-date software on the selected machine and install up-to-date or selected software/firmware/applications from the user device 308, the cloud, another work machine, node, remote computer system, etc. For example, in response to a user selection on an application hosted on the user device 308, one or more machines can be located and/or identified by one or both of a visual or audible signal from the selected machine or from the connectivity module coupled to the machine. In some embodiments, the connectivity module 320 may include one or both of a light or sound generator and may be configured to identify a machine by generating one or both of a visual or audible signal (e.g., alerts, indications, etc.). For example, the connectivity module 320 may include a beacon 326 with a light (e.g., an RGB LED light) which is lit when a user presses a button on an application (e.g., an identify machine in need of update application on a user device 308). Additionally or alternatively, the connectivity module 320 may be communicatively coupled to one or more lights (e.g., headlights, cabin lights, an incandescent light, a light emitting diode, a fixed beacon, a flashing beacon, a rotating beacon, a laser, a light array, etc.), display devices, or markers, etc. of the work machine 324 (e.g., via the control system 322) and can instruct the lights, devices, markers, etc. to generate the visible signals in response to the selection of a button on the user device 308. The beacon 326 may additionally or alternatively include a speaker to provide the audible signals. Additionally, or alternatively, the connectivity module 320 may be communicatively coupled to a horn or speaker of the work machine 324 (e.g., via the control system 322) and can instruct the horn or speaker to generate the audible signal in response to the selection of a button on the user device 308.

In some embodiments, the system for over-the-air programming for communicatively connected work machines 300 may allow a user to identify multiple machines of a plurality of machines in need of a software update or various software updates. Each machine may include a connectivity module 320 that is part of or physically coupled to the machine (e.g., machine 324). The connectivity module may be communicatively coupled to the control module 322 of the machine and may be configured to communicate with the other connectivity modules via a network connection. A user may use a user device (e.g., user device 308) configured to communicate with the one or more connectivity modules via a network connection. A user may identify machines in need of an update using an application on the user device. For example, the user may use the application to select a particular software of interest and input a desired version of the software. The application may then send a command via a network (e.g., local fleet connectivity system 200, a local area network, a mesh network comprising various work machines, etc.) to the plurality of work machines instructing each of the work machines to report back its currently installed version of the particular software. The application may then compare the currently installed version of the particular software present on each of the plurality of work machines with the desired software version. The application may then identify one or more work machines in need of a software update (e.g., the software on the work machines does not match the desired software version). The user device and/or mobile application may then physically locate the identified work machines in need of a software update.

For example, work machines in need of a software update can by physically located by one or both of an audible signal or a visual signal. For example, if a user selects machines 304 and 324 via the user device 308, machines 304 and 324 may generate an audible or visual signal using their respective horns, headlights or a machine state visual indicator coupled to the respective connectivity unit. In some embodiments, each machine is identified by a different visual or audible signal. For example, if the connectivity modules of the two or more machines each comprise a light configured to illuminate to generate the visual signal, the light of each connectivity module of the two or more machines may illuminate with a different color.

In some embodiments, the user device displays a map showing the locations of the plurality of machines in need of a software update. Machines that do not match the filter criteria (e.g., do not require a software update, reported back that the desired software was installed on the machine, etc.) may be temporarily removed from the map.

In a further example, machines or products at a work site automatically create or join a local area network (e.g., a mesh network) created by and among the assets themselves. A plurality of work machines may each be configured to wirelessly communicate with the other work machines. For example, each work machine may include a connectivity module 320 for communicating with other machines and computing systems. A first work machine may detect that a second work machine is within a signal range of the connectivity module and may automatically form a local area network with the second machine. Additional machines may join the local area network when they are brought within range of a machine or other computer system connected to the local area network. Each machine and computing system may function as a node of a mesh network. A mesh identifier may be automatically created upon creation of the mesh. A user may name the local area network using a user device connected to the local area network via at least one node. The user device may be configured to display a list of the machines connected to the local area network as a group. Each machine in the local area network may be configured to transmit machine-specific data to the other machines in the network and to the user device. Data may include a location of the machine, lists of various software/firmware/hardware installed or operative on the machine, records of previous software/firmware/hardware installed on the machine, etc.

In some embodiments, the beacon 326 acts as a machine state visual indicator. The machine state visual indicator provides a signal to an observer. For example, in response to a user selection on an application hosted on the user device 308, the machine state visual indicator of one or more machines can provide a signal to the user. The signal may indicate a state or condition of the machine (e.g., software up-to-date, software out-of-date, software installation in progress, etc.). In some examples, the machine state visual indicator is an indicator module connected to the connectivity module 320. In other examples, the machine state visual indicator may be a machine component or a separate device attached to the machine (e.g., a vehicle external light, a vehicle internal light, a beacon, etc.). The machine state visual indicator may be a light (e.g., an incandescent light, a light emitting diode, a fixed beacon, a flashing beacon, a rotating beacon, a laser, a light array, etc.), a display device, a marker, etc. In some examples, an audible indicator of a machine state may be incorporated in addition to or as an alternative to the machine state visual indicator. The audible indicator may be integrated into the connectivity module 320 or may be generated by the machine 324 (e.g., by a horn or speaker).

The machine state visual indicator is configured to generate a variety of visual signals. In some examples, the variety of visual signals comprises one or more colors, patterns, and combinations of colors and patterns. In some examples, the machine state visual indicator is configured to generate visual signals observable as a light or one or more light patterns. In some examples, the light patterns generated by the machine state visual indicator can be varied in any optical characteristic (e.g., color, wavelength, intensity, pulse duration, direction, etc.). In some examples, the machine state visual indicator may incorporate an indication of the status of the software or a software installation function on a machine (e.g., flashing green for software installation in progress, constant yellow for software installation paused, etc.).

In another example a service technician may transmit a wireless command to all machines on a work site to flash a red light if the machine controller detects a software version inconsistent with a desired software version queried or broadcast by a user device running the application according to the system for over-the-air programming for communicatively connected work machines. Additionally, the command may result in all work machines running software inconsistent with the desired software version to appear on based on their physical location on a map generated on a GUI on the user device.

In some embodiments, system for over-the-air programming for communicatively connected work machines hosted on a user device 308 presents a user interface to a user. The application user interface receives user selections of software/firmware/etc. to be monitored across one or more work machines. For example, a user selects a specific software or program version/identifier/installation date as a criterion. The user inputs are transmitted to machines 304, 324 via a network. User inputs received at the connectivity module 320 generate one or more commands to the machine (e.g., broadcast back indicating currently installed version of software/firmware/etc., flash green light if installed version matches user inputs, broadcast location if installed version does not match user input, etc.).

The system for over-the-air programming for communicatively connected work machines is configurable to function when machine power is off. For example, the work machine may receive user inputs via a Bluetooth low energy (BLE) signal received at the connectivity module 320. The BLE communications path can be configured to remain always active with power input from a machine power source (e.g., a battery). In some examples, the BLE communications channel in the connectivity module 320 remains open and the machine state visual indicator is available to display a visual signal in response to a user input in a power saving mode (e.g., modified receiver duty cycles, reduced communications/BLE intervals, lower power operation of the machine state visual indicator beacon).

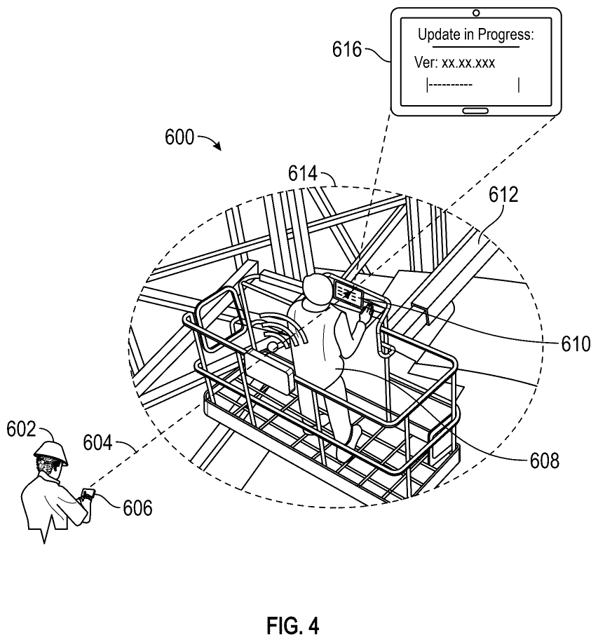

As shown in FIG. 4, after physically locating a machine in need of a software update via the system for over-the-air programming for communicatively connected work machines 600, a user 602 (or, alternatively, an operating user 608 manning the work machine 612) of the system can implement a software loading process 604 from a user device 606 to the work machine 612 on a jobsite 614. The software loading process 604 may include messages, data, and commands that identify a software version to be replaced, identify a software version and associated files to be installed, transfer the associated files and software version from the user device 606 to the work machine 612, etc. For example, the software loading process 604 and associated data/software/etc. may be received by the control system 610 of a work machine 612 and progress/status indicators associated with the software installation or update process may be displayed via a user interface on an onboard display 616. This allows the operating user 608 to receive and view the installation process without the need for the user 602 to be present in the work machine 612. Because the work machine 612 is connected to the remote device 606 (e.g., via a connectivity module 218) the user 602 was able to receive the location of the work machine 612 and may also receive the locations of other work machines on the jobsite 614 in need of similar or different software updates. The user 602 may use the location information to locate additional work machines in need of software updates and similarly perform local installation of software/firmware/etc. via the system for over-the-air programming for communicatively connected work machines 600.

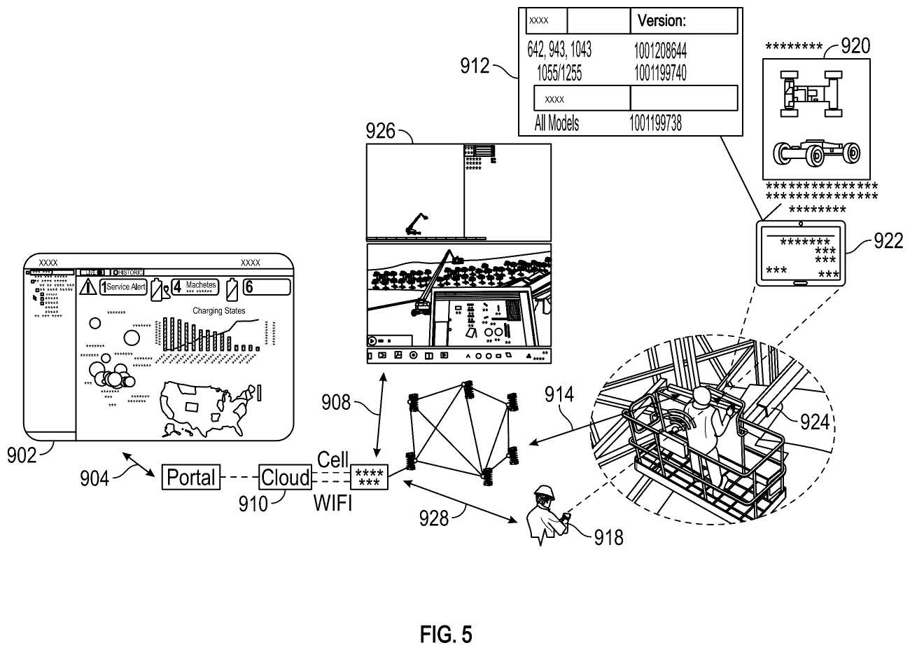

As shown in FIG. 5, various user interfaces are available to be displayed on a user device 918 and an onboard display 922 of a work machine 924. A connectivity hub 910 may send and receive data 928, 908, 904 914 including the user interfaces 902, 906, 912, 916, 926, 920. The user interface 902 is a machine status display that shows location, listing of installed software, firmware, software versions, etc., and alerts relating to a plurality of work machines. User interface 926 shows a digital twin of a work machine that may display software versions related to various aspects of the work machine, display which of the various software versions/applications/firmware operating on the work machine are up-to-date, out-of-date, etc. User interface 912 is a list of software/applications/firmware operating on the work machine 924. User interface 920 is a detailed schematic of the work machine 924 which likewise may list corresponding software versions, applications, etc. associated with the work machine that may need period updates. A user device 918 may use one or more of these various interfaces to display, engage with, initiate, select, or identify software updates and implement the corresponding process of updating the selected software/firmware/etc. on the work machine.

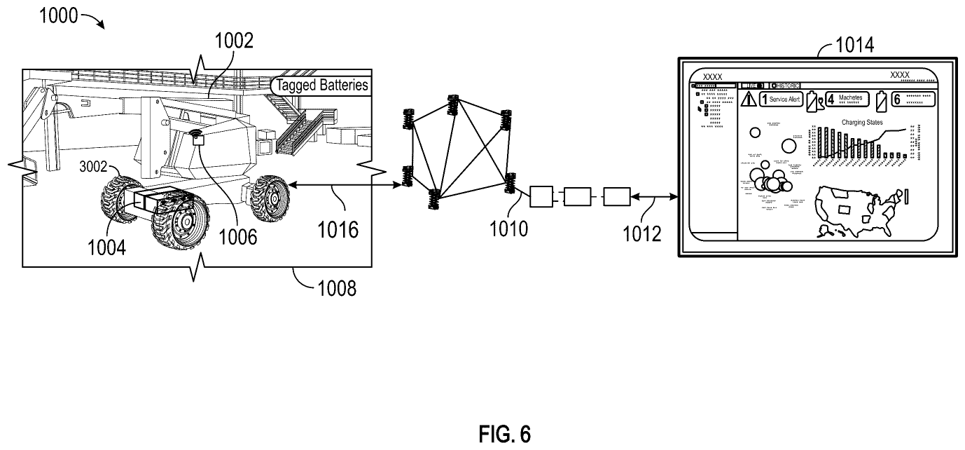

As shown in FIG. 6, the system for over-the-air programming for communicatively connected work machines has identified a work machine 1002 in need of a software update. Work machine 1002 may be identified via a communication hub/mobile application/user device/etc. A user may view the software on the work machine 1002 on a user device locally and initiate an update at the user device that then uploads desired software to the control module and/or the work machine 1002. The connectivity hub 1010 may send and receive data 1012 to and from a user interface 1014 on the user device in connection with the software update.

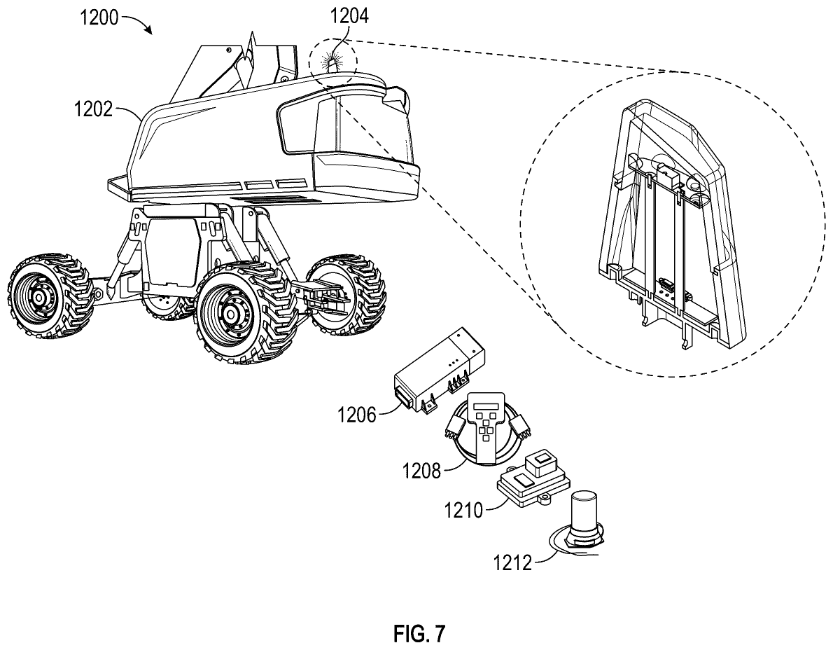

Referring to FIG. 7, a work machine 1202 at a worksite 1200 is provisioned with an indicator 1204 (e.g., a connectivity module with integrated beacon light, control devices, and communications devices). The indicator 1204 may, for example, illuminate a light visible to a user in response to user activation of a “find machine in need of update” command on an application hosted on a user device connected to the system for over-the-air programming for communicatively connected work machines 300. The indicator 1204 may function like a conventional work machine warning beacon 1212.

In some embodiments, the connectivity module may be configured with a telematics control unit 1206, a multi-function light beacon 1212, one or more multi-channel communication modems 1210, one or more analytics devices 1208, one or more antennas, one or more power sources, one or more positioning systems, one or more local fleet connectivity processors, and one or more interface blocks, one or more machine connectivity provisions, and one or more memory devices. For example, the connectivity module with integrated beacon 1204 may be configured as an integrated connectivity device provisioned with all components required to connect a work machine 1202 that is not provisioned with networking equipment to the system for over-the-air programming for communicatively connected work machines 300. The connectivity module with integrated beacon 1204 may include, for example, a telematics control unit specific componentry included (e.g., multi-color beacon, GPS/GNSS, communications modem, antenna, controller, memory device, interface blocks, housing, etc.) and be affixable to a work machine using temporary or permanent physical, electrical, or electronic connections. The connectivity module connected to the work machine may be configured to selectively enable, activate, disable, and deactivate components of the connectivity module and the work machine to which it is communicatively connected. For example, a connectivity module with integrated beacon 1204 connected to a work machine equipped with headlights may enable and activate the work machine headlights and disable the integral beacon in response to a “find machine in need of update” command received by the connectivity module from the system for over-the-air programming for communicatively connected work machines 300. Additionally, the connectivity module connected to the work machine may broadcast the location of the work machine 1202 in response to an indication that the work machine 1202 requires a software update. The connectivity module with integrated beacon 1204 is configured, in some embodiments, to communicate with the control module of the work machine 1202 to determine what software version should be reported to a user device and/or mobile application in response to a command from the system for over-the-air programming for communicatively connected work machines 300.

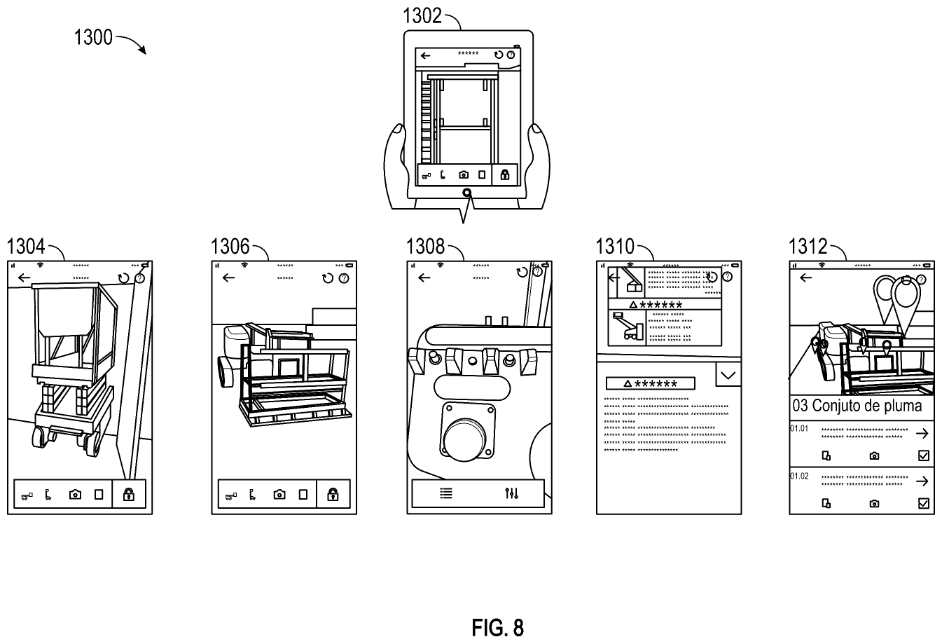

Referring to FIG. 8, a series of user interface views of a system for over-the-air programming for communicatively connected work machines 1300 is shown according to some embodiments. A first user interface view, shown as view 1302, may include a model of a machine 202 to view various software versions installed on the machine 202 when the machine 202 is in a location visible through a camera of a user device. A second user interface view, shown as view 1304, may be another view including a model of a machine 202, the process of updating or implementing a software loading process locally between the user device and machine 202 may require that the machine 202 be visible through the camera of the user device (e.g., to ensure that the correct machine is receiving the software update). A third user interface view, shown as view 1306, may include a picture of a machine 202 and interactive points to enable a user to identify the machine 202 and obtain more information about the software/firmware/hardware installed or operative on the machine 202. A fourth user interface view, shown as view 1308, may include an image of a portion of a machine 202 as seen via the camera of the user device and interactive points to enable a user to identify software affecting or operable on parts of the portion of the machine and to obtain information about the version/date/functionality of the software operating on the parts. A fifth user interface view, shown as view 1310, may include a picture of a machine decal as seen via the camera of the user device and display a listing of the software installed on the machine. A sixth user interface view, shown as view 1312, may include a plurality of software versions to install on a machine and an image of a selected option relative to a location visible through the camera of the user device.

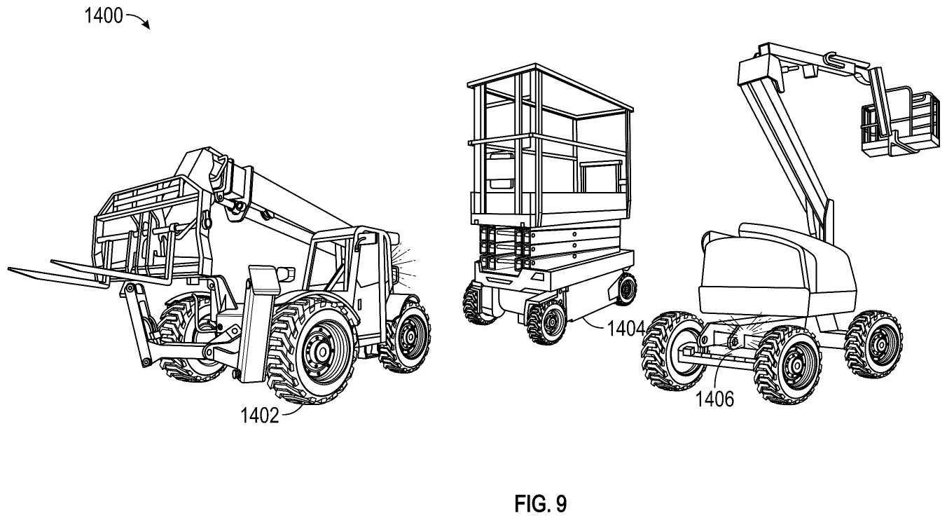

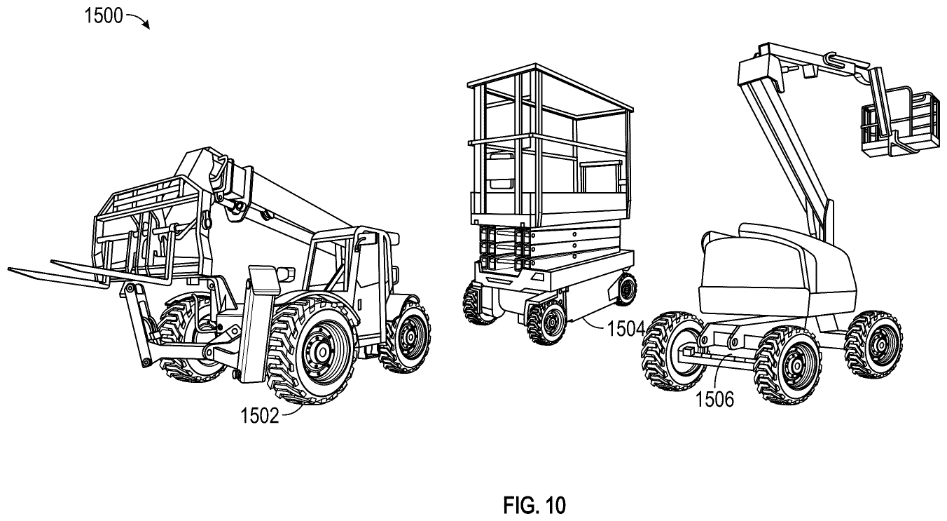

As shown in FIGS. 9-11, individual work machines 1402, 1404, 1406, 1502, 1504, 1506, 1602, 1604, 1606 at a work site 1400, 1500, 1600 automatically connect to one another on a local area network, for example via local fleet connectivity system, via a mesh network, etc.

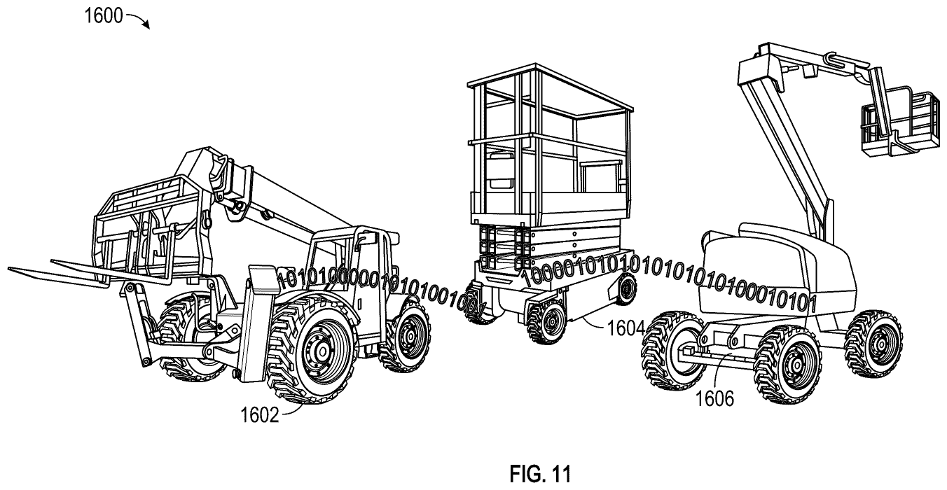

Referring now to FIG. 11, machines 1602, 1604, 1606 connected to the fleet connectivity system, local area network, etc. may transmit information to the cloud for data processing and for simple fleet management. In other words, all machines on a particular jobsite could easily be identified and accessed and grouped by site. Products, for example work machines 1602, 1604, 1606, automatically create or join a mesh network, (e.g., a local fleet connectivity system 200) created by and among the assets themselves. A mesh identifier is automatically created upon creation of the mesh. Whenever two or more assets are there, they talk across the same network. The system and methods for over-the-air programming for communicatively connected work machines is agnostic as to machine type, manufacturer, owner, status, etc. as the system provides for machines and communicates to machines, including machines from different manufacturers to be part of the same network through, for example, connectivity modules.

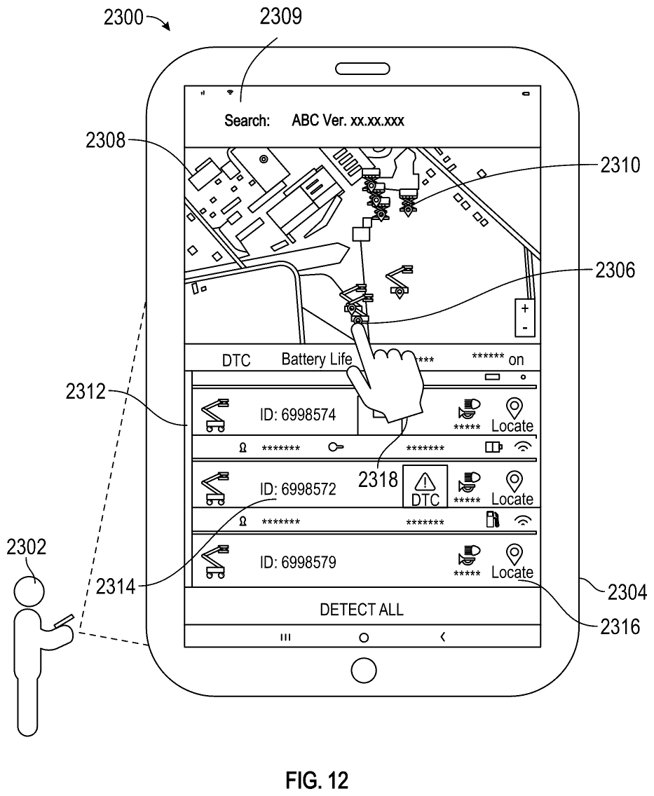

Referring to FIG. 12, a user 2302 may use the system for over-the-air programming for communicatively connected work machines by interacting 2318 with an application hosted on a user device 2304 that generates a user interface 2308. The user device 2304 and various work machines 1202 are interconnected via a local fleet connectivity system, local area network, nesh network, remote computer system, etc. The user 2302 selects a desired software version, software of interest, update to apply to out-of-date machines, etc. 2309. The application may then broadcast/send a command via a network (e.g., local fleet connectivity system 200, a local area network, a mesh network comprising various work machines, etc.) to the plurality of work machines instructing each of the work machines to report back its currently installed version of the particular software. The broadcast may also identify work machines and issue a query to a remote system for the latest software versions installed on the work machines or obtain the software versions operating on the plurality of work machines by communicating with various nodes on the network. The application may determine which work machines of the plurality of work machines require a software update (e.g., by comparing the currently installed version of the particular software present on each of the plurality of work machines with the desired software version, etc.). The application may then identify one or more work machines in need of a software update (e.g., the software on the work machines does not match the desired software version) and provide a physically location of an identified machine 2306 from a view of a group of a machines 2310 connected to the local fleet connectivity system (or local area network, etc.) at a work site. The user interface 2308 may depict, for example, imagery of a work site with overlays of machine locations (e.g., a map) 2310 and information regarding machine specific information (e.g., location, currently operative software, installed hardware/firmware, time since last software update, etc.) 2312, 2314, 2316. The application may dynamically filter the map to illustrate the total machine population and locations and statuses of individual machines in the population (e.g., machines with out-of-date software, machines needing particular software updates, etc.) In some examples, a remote user may apply filters (e.g., proximity to a user, filters related to machine status including time since last update, etc.) to a specific work site network much the same as can be done locally via an application on a mobile user device (e.g., in the instance where a remote user can apply the desired user configurable rules to assist a local user without the need of mobile application use). The user may select a machine or group of machines using an application and communicate with the machine or group of machines (directly or via a cloud) to have that machine provide a software identify indication or software installation required indication (e.g., a colored light, a light pattern, a combination of light colors and patterns, activation of a horn).

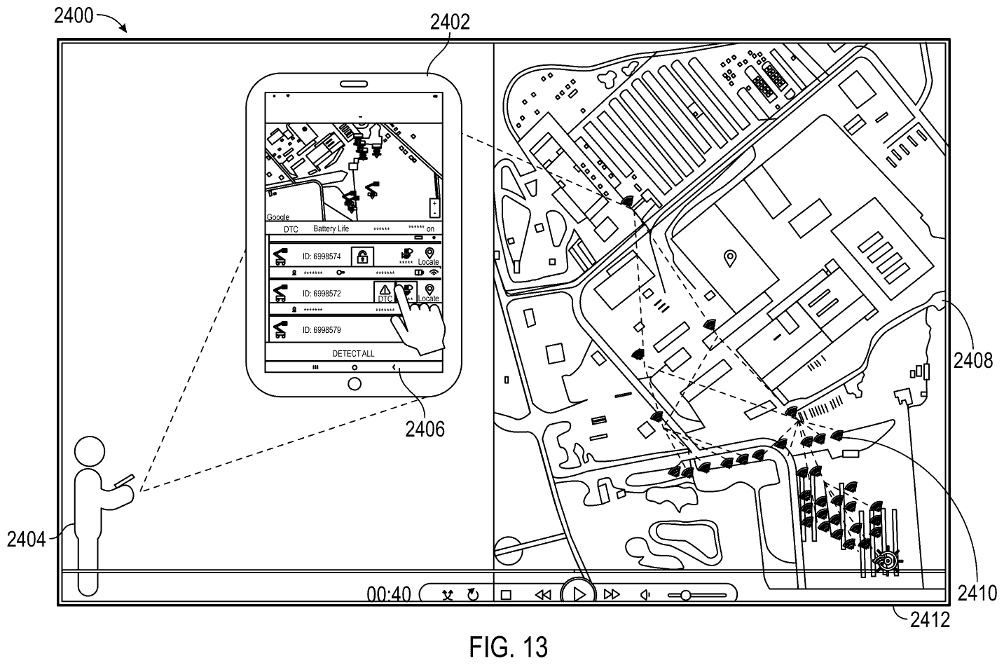

Referring to FIG. 13, a user interface 1800 of an application operating a system for over-the-air programming for communicatively connected work machines is shown, according to an exemplary embodiment. The user interface 2400 may include a map 2408. The map 2408 may highlight of indicate the location of machines determined to be in need of a software update. The user may then navigate to the machines in need of a software update and transfer the files associated from the update from the user device directly to the machine. The map may be an aerial view of a job site. The map 2408 may include machine indicators 2410 that show where machines are disposed on the map 2408. A light on a connectivity module can be used to identify a first machine 2412 of the plurality of machines within the job site and indicate various statuses of the first machine (e.g., software up-to-date, software out-of-date, etc.). The application user interface 2406 on user device 2402 can be used by a user 2404 to select which status they want to be displayed on a fleet within user defined parameters (e.g., scan for operating versions of software A, determine which machines are operating an out-of-date version of software B, etc.). Features of the “find machine in need of update” application can be used independently of or in conjunction with the filter criteria of a desired subset of a fleet. The system for over-the-air programming for communicatively connected work machines application can also provide user interfaces for other instructions or commands (e.g., allowing a machine to be powered up or shut down, to reboot certain systems after installing the software update, etc.). The user 2404 may then navigate to the machine in need of an update and implement the software loading process (e.g., install the software update) locally by transferring the software filed from a mobile device to the command module/machine in need of the software update.

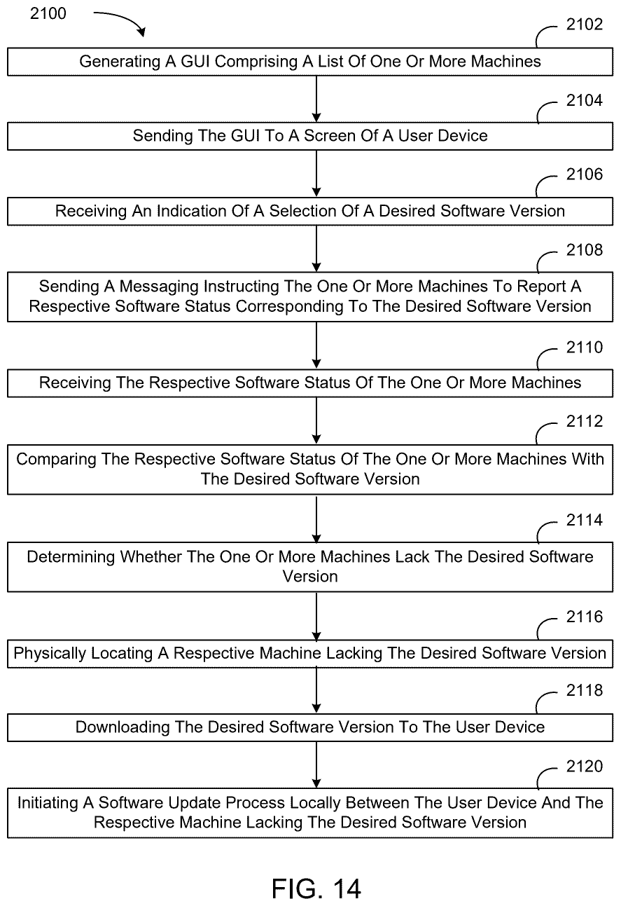

Referring to FIG. 14, a process 2100 (or method) for a system for over-the-air programming for communicatively connected work machines is shown according to some embodiments. The method may be performed by one or more processing circuits comprising one or more memory devices coupled to one or more processors. The one or more memory devices may be configured to store instructions thereon that, when executed by the one or more processors, cause the one or more processors to perform the operations of the method. In some embodiments, the one or more processing circuits may be integrated into a remote computing system (e.g., cloud and web services 268). In other embodiments, the one or more processing circuits may be integrated into a user device (e.g., user device 272). One or more machines may connect to the user device via a local wireless connectivity system or via a cellular network (e.g., via cell towers 240), or other existing or new means of digital connectivity. Each machine may include a connectivity module for communicating with the system for over-the-air programming for communicatively connected work machines (e.g., connectivity modules 218, 320). The one or more processing circuits may communicate across a wireless network by sending messages to the one or more machines and to one or more user devices each communicatively connected to the system. A user may interact with the machines via an application provided on the user device that displays a graphical user interface (GUI).

Following the activation of system for over-the-air programming for communicatively connected work machines and deployment of machines to a work site, machines connect to the system and are identified digitally within the system and applications provided through the system. Process 2100 begins at operation 2102 with the generation of a GUI including a list of one or more of the machines connected to the system for over-the-air programming for communicatively connected work machines. In some embodiments, the list may automatically include additional information regarding each machine (e.g., current software version installed, time since last software update, fuel level/SOC, DTC status, ignition on/off, in operation, etc.). In some embodiments, the list may automatically include location information regarding each machine (e.g., work site name, latitude and longitude, etc.). In some embodiments, the GUI may automatically include a map with the location of each machine, as shown in FIG. 12. At operation 2104, the GUI is sent to a screen of a user device for display. The user device may be, for example, a smartphone, a tablet computer, a laptop computer, a desktop computer, or any device with a screen to display the GUI and that allows the user to interact with the application (e.g., to receive machine data, to send messages, instructions, or commands to the machines, etc.).

At operation 2106, an indication of a selection of desired software version is received via the GUI. For example, a user may select a desired software version by clicking on a desired software version from a list of software versions displayed on the GUI, entering a desired software versions into a command prompt on the user device, searching for a specific software version, etc. on the list of software on the GUI with a mouse or touching it on a touchscreen device. At operation 2108, in response to receiving the selection of the desired software version, an instruction is sent to one or more machines to report the respective version of the software that is currently operating on each respective machine (e.g., a respective software status corresponding to the desired software version). The instruction may also result in the machines reporting that no software is installed, that the software found is out of date, or otherwise result in the user device receiving an indication of the software installed on a machine of interest (e.g., sending an instruction to a database of currently installed software versions to determine which version is installed on a machine of interest). It should be understood that instructing the machine to report a respective software status may include instructing a connectivity module coupled to the machine to report the status or otherwise generate a corresponding indication of software status. At operation 2110, the respective software status of the one or more machines is received and may be displayed on the GUI. At operation 2112, the respective software status of the one or more machines is compared with the desired software version. At operation 2114, the system determines whether the one or more machines lack the desired software version. For example, the user device, mobile application, etc. may determine that the desired software version is not the same as the software version currently operating on one or more of the machines. The system may also determine that one or more of the machines lacks any software version, that the software version on a machine is corrupt or requires maintenance, etc.

At operation 2116, one or more machines lacking the desired software version or otherwise requiring a software update is physically located. The location of the machine may be displayed via the GUI (e.g., displayed on a map, longitude latitude of the machine, building location and serial number of the machine, etc.). For example, the user may identify the machine requiring a software update based on the visual or audible indication generated by an indicator. The indicator may be, for example, a beacon integrated into the connectivity module that includes a light which is lit when the instruction to generate the indication is received. Additionally, or alternatively, the connectivity module can instruct the machine's lights (e.g., headlights, cabin lights, etc.) to act as the visible indicator. The beacon may additionally or alternatively include a speaker to provide the audible indication. Additionally, or alternatively, the connectivity module can instruct the machine's horn to act as the audible indicator. The visual and audible indicators can be used in conjunction or independently of one another.

At operating 2118, the desired software version is download to the user device. At operation 2120, a software update process is initiated locally between the user device and the respective machine of the one or more machines lacking the desired software version (e.g., the user device communicates, uploads, transmits, etc. the files associated with the update to the machine). In another embodiment, the desired software update and/or the files associated with the update to the machine may be received at the communication module of the machine. The connectivity module may then “hold” the files and/or software update until the connectivity module receives a signal indicating that the files and/or software update should be applied, installed, or otherwise communicated to the work machine. In this way, the system, user device, or the like may initiate installation and/or communication of the software update/files from the communication module to the work machine remotely, from afar, at a designated point in time after downloading the software update to the connectivity module, etc. Accordingly, the software update may not be immediately installed to the work machine and may be held and/or stored locally on the connectivity module (e.g., until an administer approves of causing the software update, until a user satisfies a condition/pays a fee/meets a credential requirement, etc. to unlock the software update, until a signal indicating the machine has access/approval to use the software update is received, or the like).

As an example of process 2100, a worksite may have ten machines (e.g., scissor lifts) that are the same model. The scissor lifts may connect to system for over-the-air programming for communicatively connected work machines. A user device (e.g., a tablet computer) may also connect to the system for over-the-air programming for communicatively connected work machines. A GUI may be generated and displayed on the screen of the tablet computer. The GUI may include a list of the ten scissor lifts and a list of software versions operating on the respective scissor lifts. If, for example, one of the scissor lifts is operating an out-of-date software version, the user may identify that scissor lift (e.g., by running a search for machines not running a specific software version, by issuing command for all machines to report their current software versions, etc.). After the out-of-date software is identified, an instruction may be sent to the selected scissor lift to activate the beacon light of the connectivity module coupled to the selected scissor lift and generate a visual indication or to broadcast its location so that the scissor lift's physical location may be identified. The user may then locate the selected scissor lift based on the visual indication and/or its broadcast location (e.g., shown on a map on a user interface of the tablet computer). Once located, the user may download the up-to-date software and locally install the update software on the scissor lift from the tablet computer.

Although the systems and methods are described herein with reference to a lift device, a lift assembly, or a work machine, the systems and methods may additionally or alternatively be applied to any other type of vehicle or machine. By way of example, these systems and methods may apply to any type of lift device (e.g., boom lifts, scissor lifts, vertical lifts, manual lifts, aerial work platforms, telehandlers, etc.). By way of another example, these systems and methods may apply to vocational vehicles, such as fire fighting vehicles, fire trucks, concrete mixers, delivery vehicles, military vehicles, refuse vehicles, etc.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

While various circuits with particular functionality are shown in FIGS. 1-3, it should be understood that the controller 44 may include any number of circuits for completing the functions described herein. For example, the activities and functionalities of the control system 60 may be combined in multiple circuits or as a single circuit. Additional circuits with additional functionality may also be included. Further, the controller 44 may further control other activity beyond the scope of the present disclosure.

As mentioned above and in one configuration, the “circuits” of the control system 60 may be implemented in machine-readable medium for execution by various types of processors, such as the processor 52 of FIG. 1. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively, or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Although this description may discuss a specific order of method steps, the order of the steps may differ from what is outlined. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

It is important to note that the construction and arrangement of the load map interface systems and methods as shown in the various exemplary embodiments is illustrative only. Additionally, any element disclosed in one embodiment may be incorporated or utilized with any other embodiment disclosed herein. For example, the warning zones of the exemplary embodiment may be eliminated or additional zones may be added. Although only one example of an element from one embodiment that can be incorporated or utilized in another embodiment has been described above, it should be appreciated that other elements of the various embodiments may be incorporated or utilized with any of the other embodiments disclosed herein.

Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A system for over-the-air programming for a work machine, the system comprising:
a connectivity module, the connectivity module communicatively and physically coupled to the work machine;
one or more processing circuits comprising one or more memory devices coupled to one or more processors, the one or more memory devices configured to store instructions thereon that, when executed by the one or more processors, cause the one or more processors to:
designate a desired software version;
receive an indication of a software version installed on the work machine;
based on the indication of the software version installed on the work machine, determine whether the work machine is eligible to receive the desired software version;
send the desired software version to the connectivity module physically coupled to the work machine;
after sending the desired software version to the connectivity module, send a command to initiate an installation of the desired software version from the connectivity module to the work machine; and
cause the desired software version to install to the work machine via the connectivity module.

2. The system of claim 1, wherein the one or more memory devices are configured to store instructions thereon that, when executed by the one or more processors, further cause the one or more processors to:
identify the work machine as a member of a group of one or more work machines in need of the desired software version.

3. The system of claim 2, wherein a location of each member of the group of one or more work machines in need of the desired software version is displayed on a graphical user interface (GUI) that includes a real-time map.

4. The system of claim 1, wherein the one or more memory devices are configured to store instructions thereon that, when executed by the one or more processors, further cause the one or more processors to:
physically locate the work machine, and
send an instruction to the work machine to cause the work machine to illuminate a light or generate a sound, either with a beacon integrated into the connectivity module or with a light and horn of the work machine.

5. The system of claim 1, further comprising:
a user device comprising a GUI and including at least one of a laptop, a cellular device, a tablet, a computer, or a remote computer system, the user device configured to:
receive, via the GUI, a designation of at least the work machine; and
receive an indication of approval of the desired software version as a prerequisite to the installation of the desired software version from the connectivity module to the work machine.

6. The system of claim 1, wherein the work machine is one work machine of a plurality of work machines, each work machine of the plurality of work machines comprising:
a controller coupled to the respective work machine and configured to:
receive the software version associated with the respective work machine;
store the software version locally on the respective work machine;
receive a request to report the software version from a user device; and
provide the software version stored locally on the respective work machine to the user device in response to the request.

7. The system of claim 6, wherein the plurality of work machines establishes a local mesh network.

8. A system for over-the-air programming for a work machine, the system comprising:
one or more processing circuits comprising one or more memory devices coupled to one or more processors, the one or more memory devices configured to store instructions thereon that, when executed by the one or more processors, cause the one or more processors to:
receive an indication of a selection of a desired software version,
receive a software status of the work machine, the software status corresponding to the desired software version,
compare the software status of the work machine with the desired software version,
send the desired software version to at least one of a user device, a connectivity module coupled to the work machine, or the work machine,
send a signal to initiate a software update process locally between the connectivity module and the work machine, and
cause, responsive to sending the signal, the desired software version to install to the work machine via the connectivity module.

9. The system of claim 8, further comprising:
the user device comprising a screen and including at least one of a laptop, a cellular device, a tablet, a computer, or a remote computer system;
wherein the one or more memory devices are configured to store instructions thereon that, when executed by the one or more processors, further cause the one or more processors to:
generate a graphical user interface (GUI) comprising a list of at least the work machine, and
send the GUI to the screen of the user device.

10. The system of claim 9, wherein the one or more memory devices are configured to store instructions thereon that, when executed by the one or more processors, further cause the one or more processors to:
send, in response to receiving the indication of the selection of the desired software version, an instruction to the work machine to report to the software status corresponding to the desired software version to the user device.

11. The system of claim 8, wherein the desired software version is sent to at least one of the user device, the connectivity module coupled to the work machine, or the work machine in response to the comparison indicating that the work machine lacks the desired software version.

12. The system of claim 8, wherein the one or more memory devices are configured to store instructions thereon that, when executed by the one or more processors, further cause the one or more processors to physically locate the work machine.

13. The system of claim 12, wherein the one or more memory devices are configured to store instructions thereon that, when executed by the one or more processors, further cause the one or more processors to send an instruction to the work machine to cause the work machine to illuminate a light or generate a sound, either with a beacon integrated into the connectivity module or with a light and horn of the work machine.

14. The system of claim 8, wherein the work machine is one work machine of a plurality of work machines, each work machine of the plurality of work machines comprising:
a controller coupled to the respective work machine and configured to:
receive a software version associated with the respective work machine;
store the software version locally on the respective work machine;
receive a request to report the software version from the user device; and
provide the software version stored locally on the respective work machine to the user device in response to the request.

15. A method of over-the-air programming for a work machine, the method comprising:
receiving an indication of a selection of a desired software version;
sending, in response to receiving the indication of the selection of the desired software version, an instruction to the work machine to report a respective software status corresponding to the desired software version;
receiving the respective software status of the work machine;
comparing the respective software status of the work machine with the desired software version;
determining whether the work machine lacks the desired software version;
sending the desired software version to a connectivity module coupled to the work machine;
initiating a software update process locally between the connectivity module and the work machine lacking the desired software version; and
causing the work machine to receive the desired software version.

16. The method of claim 15, further comprising:
generating a graphical user interface (GUI) comprising a list of at least the work machine; and
sending the GUI to a screen of a user device.

17. The method of claim 16, wherein the GUI comprises a map illustrating a total machine population, and further comprising:
filtering, in response to an input from the user device, the map to identify only one or more work machines in need of the desired software version.

18. The method of claim 16, further comprising:
reporting to the user device the respective software status of the work machine corresponding to the desired software version.

19. The method of claim 16, further comprising:
physically locating, via the GUI, the work machine; and
causing the work machine to illuminate a light or generate a sound, either with a beacon integrated into the connectivity module or with a light and horn of the work machine.

20. The method of claim 15, wherein initiating the software update process locally between the connectivity module and the work machine lacking the desired software version is in response to receiving a user input indicative of approval of the desired software version from a user device.
